(19) United States
(12) Patent Application Publication
(10) Pub. No.: US 2025/0298341 A1
(43) Pub. Date: Sep. 25, 2025

(54) IMAGE FORMING APPARATUS

(71) Applicant: FUJIFILM Business Innovation Corp., Tokyo (JP)

(72) Inventor: WENXIANG GE, Kanagawa (JP)

(73) Assignee: FUJIFILM Business Innovation Corp., Tokyo (JP)

(21) Appl. No.: 18/791,378

(22) Filed: Jul. 31, 2024

(30) Foreign Application Priority Data
Mar. 22, 2024 (JP) 2024-045916

(51) Int. Cl. G03G 15/08; G03G 15/00

(52) U.S. Cl. CPC G03G 15/0865; G03G 15/0856; G03G 15/5041

(57) ABSTRACT

An image forming apparatus includes plural development devices that accommodate different types of developers from each other, a first replenishment unit that replenishes a developer to at least one development device of the plural development devices in a case where a density of the developer in the at least one development device is a predetermined value, a second replenishment unit that replenishes the developer to a remaining development device of the plural development devices in a case where a density of the developer in the remaining development device is a predetermined value, and a control unit that controls the first replenishment unit to be activated at a same timing as an activation timing of the second replenishment unit.

### CROSS-REFERENCE TO RELATED APPLICATIONS

This application is based on and claims priority under 35 USC 119 from Japanese Patent Application No. 2024-045916 filed Mar. 22, 2024.

### BACKGROUND

### (i) Technical Field

The present invention relates to an image forming apparatus.

### (ii) Related Art

JP1997-22156A (claim 1, FIG. 1 and FIG. 2) describes an image forming apparatus including first and second development devices, an image density detection unit, a first replenishment unit, a ratio detection unit, and a second replenishment unit.

The first and second development devices accommodate two-component developers. The image density detection unit detects a density of a reference toner image developed by the first development device. The first replenishment unit replenishes a toner to the first development device according to an image density. The ratio detection unit detects a ratio of the toner to a carrier in the second development device. The second replenishment unit replenishes a toner to the second development device at a ratio.

In addition, JP1997-22156A (claim 1, FIG. 1 and FIG. 2) describes that a volume resistivity of a carrier of the first development device is set to be lower than a volume resistivity of the carrier of the second development device.

JP1997-190069A (claim 1, FIG. 1 and FIG. 3) describes an electrophotographic apparatus including a plurality of development devices around an identical photosensitive body.

In addition, JP1997-190069A (claim 1, FIG. 1 and FIG. 3) describes that a toner density of each of the development devices is controlled by different toner density control units in accordance with a color and a capacity of the toner accommodated in each of the development devices.

### SUMMARY

In an image forming apparatus including a first replenishment unit that replenishes a developer to at least one of a plurality of development devices and a second replenishment unit that replenishes a developer to the remaining development device of the plurality of development devices, an image forming operation being executed is interrupted by a replenishment operation of the developer.

Aspects of non-limiting embodiments of the present disclosure relate to an image forming apparatus that can reduce interruption of an image forming operation due to a replenishment operation of a developer as compared with a case where a first replenishment unit and a second replenishment unit are individually activated without adjusting an activation timing of each other.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present invention, there is provided an image forming apparatus including a plurality of development devices that accommodate different types of developers from each other, a first replenishment unit that replenishes a developer to at least one development device of the plurality of development devices in a case where a density of the developer in the at least one development device is a predetermined value, a second replenishment unit that replenishes the developer to a remaining development device of the plurality of development devices in a case where a density of the developer in the remaining development device is a predetermined value, and a control unit that controls the first replenishment unit to be activated at a same timing as an activation timing of the second replenishment unit.

### BRIEF DESCRIPTION OF THE DRAWINGS

Exemplary embodiment(s) of the present invention will be described in detail based on the following figures, wherein:

FIG. 1 is a schematic diagram showing an image forming apparatus according to a first exemplary embodiment;

FIG. 2 is a schematic diagram showing a portion related to developer replenishment of the image forming apparatus of FIG. 1;

FIG. 3 is a block diagram showing a portion related to control of the image forming apparatus of FIG. 1;

FIG. 4 is a flowchart showing a flow of a control operation related to adjustment of an activation timing of a replenishment device;

FIG. 5 is a flowchart showing a flow of a control operation related to ATC; and

FIG. 6 is an explanatory diagram illustrating a state of a replenishment operation of the replenishment device and interruption of an image forming operation in each of a comparative example and an example.

### DETAILED DESCRIPTION

Hereinafter, exemplary embodiments of the present invention will be described in detail with reference to the accompanying drawings.

### First Exemplary Embodiment

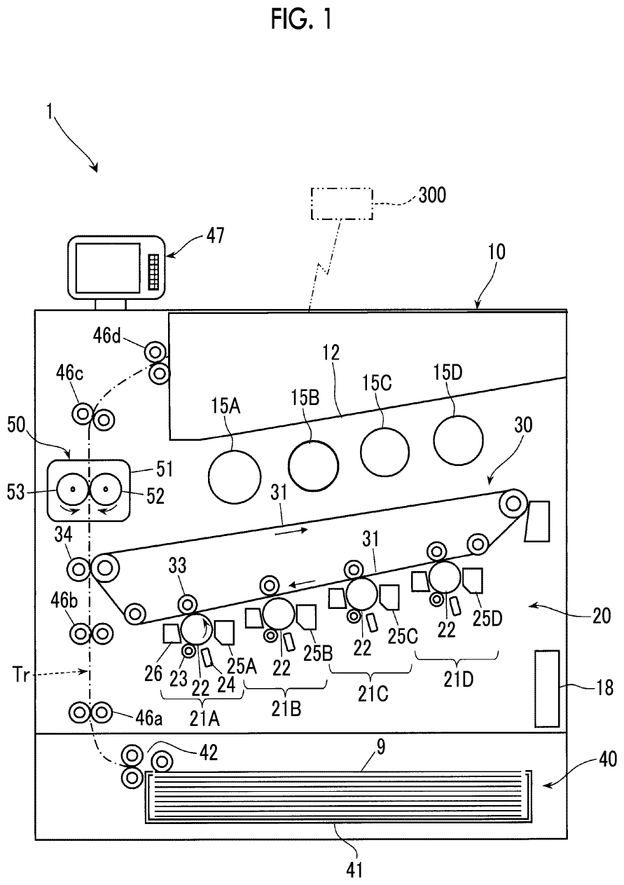

FIG. 1 is a schematic diagram of an image forming apparatus 1 according to a first exemplary embodiment of the present invention.

In the present specification and the drawings, substantially identical components are denoted by identical reference numerals. In addition, in the present specification, the duplicate description of the identical component is omitted.

The image forming apparatus 1 is, for example, a printer.

In addition, as shown in FIG. 1, in the image forming apparatus 1, an imaging section 20, an intermediate transfer section 30, a sheet feeding section 40, a fixing section 50, and the like are arranged inside a housing 10.

In the housing 10, a sheet discharge and accommodation section 12 is provided on an upper portion thereof, and a manipulation display panel section 47 is provided on an upper surface portion thereof. The manipulation display panel section 47 is a section having a display that displays information necessary for an operation and the like and a manipulation section that is used to perform a manipulation necessary for an operation and the like.

The imaging section 20 is a section that forms developed images obtained by developing latent images with a developer.

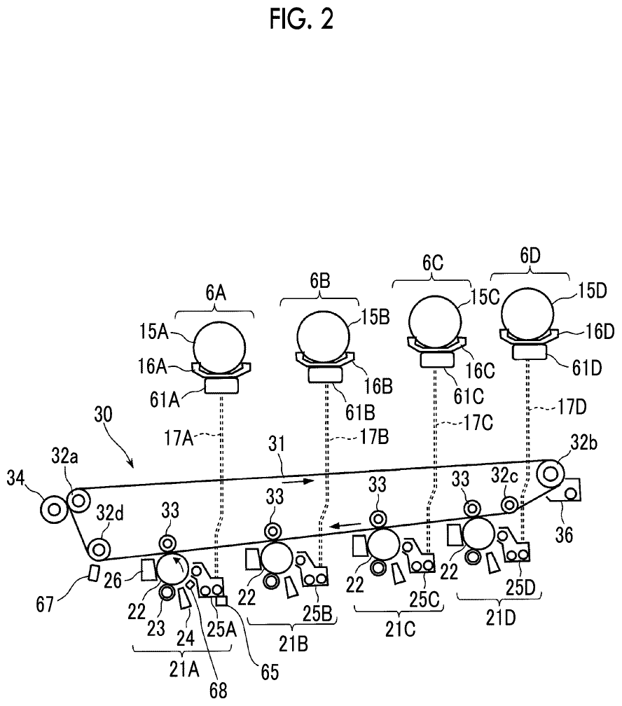

As shown in FIG. 1 and FIG. 2, the imaging section 20 according to the first exemplary embodiment includes four imaging units 21A, 21B, 21C, and 21D.

The imaging units 21A, 21B, 21C, and 21D each have a photosensitive drum 22. The imaging units 21A, 21B, 21C, and 21D form developed images developed by developers of predetermined colors (A, B, C, and D) on the photosensitive drums 22 by an electrophotographic method.

Examples of the predetermined colors (A, B, C, and D) include colors such as black, cyan, magenta, and yellow.

In the imaging section 20, the photosensitive drums 22 in the imaging units 21A, 21B, 21C, and 21D rotate in a direction indicated by an arrow.

Then, an outer peripheral surface of each photosensitive drum 22 is charged to a predetermined surface potential by each charging device 23.

Thereafter, on the charged outer peripheral surface of each photosensitive drum 22, an image exposure of each color component formed to correspond to image information is performed from each latent image forming device 24. As a result, electrostatic latent images of the predetermined color components (A, B, C, and D) are allocated and formed on the outer peripheral surfaces of the photosensitive drums 22.

The image information is input from an external connection device 300, such as an information terminal or a storage medium, connected to the image forming apparatus 1.

Subsequently, in each photosensitive drum 22, the electrostatic latent image formed on the outer peripheral surface thereof is developed by the developer of the corresponding color fed from each of development devices 25A, 25B, 25C, and 25D.

For example, a two-component developer containing a toner and a carrier is used as the developer. In a case where the developer is the two-component developer, a toner image consisting of toners of predetermined colors (A, B, C, and D) is obtained as the developed image.

Since the development devices 25 are different from each other in that the development devices accommodate the developers containing the toners of different colors (A, B, C, and D), the development devices 25 are displayed as the development devices 25A, 25B, 25C, and 25D.

In all of the development devices 25A, 25B, 25C, and 25D, a developing roll, a mixing and conveying member, a layer thickness regulation member, and the like (not shown) are arranged inside an accommodation container that accommodates a developer.

On the outer peripheral surfaces of the photosensitive drums 22, the toner images of the predetermined colors (A, B, C, and D) are formed by development operations of the development devices 25A, 25B, 25C, and 25D.

In the imaging section 20, the toner images of the colors formed on the photosensitive drums 22 are transferred to the intermediate transfer section 30.

In addition, in the imaging section 20, a surface of each of the photosensitive drums 22 after the transfer is cleaned by a drum cleaning device 26 to prepare for a next imaging step.

The intermediate transfer section 30 is a section that temporarily retains the toner images of the predetermined colors formed by the imaging units 21A, 21B, 21C, and 21D of the imaging section 20 on an intermediate transfer belt 31 by primary transfer and then secondarily transfer the toner images onto sheet 9.

In the intermediate transfer section 30, the intermediate transfer belt 31 is wound around a plurality of rolls 32a, 32b, 32c, and 32d and rotates in a direction indicated by an arrow.

Then, in the intermediate transfer section 30, on an outer peripheral surface of the rotating intermediate transfer belt 31, the toner images of the colors on the photosensitive drums 22 are sequentially primarily transferred by a primary transfer device 33.

Thereafter, the rotating intermediate transfer belt 31 conveys the toner images primary-transferred onto the outer peripheral surface thereof to a secondary transfer position facing a secondary transfer device 34.

In the intermediate transfer section 30, the toner images primary-transferred onto the outer peripheral surface of the intermediate transfer belt 31 are secondarily transferred onto the sheet 9 fed from the sheet feeding section 40 by the secondary transfer device 34.

In addition, in the intermediate transfer section 30, the outer peripheral surface of the intermediate transfer belt 31 after the secondary transfer is cleaned by a belt cleaning device 36 to prepare for a next transfer step.

The sheet feeding section 40 is a section that accommodates the sheet 9 on which images are to be formed and feeds the sheet 9 to the secondary transfer position of the intermediate transfer section 30.

In the sheet feeding section 40, sheets 9 are sent one by one from an accommodation body 41 that accommodates the sheets 9 to a sending device 42 to the secondary transfer position of the intermediate transfer section 30.

A plurality of sets of the accommodation body 41 and the sending device 42 may be assembled.

In addition, the sheet feeding section 40 is connected to a sheet conveyance path Tr indicated by a dashed dotted line.

The sheet conveyance path Tr is provided to connect the sheet feeding section 40 and the sheet discharge and accommodation section 12 via the secondary transfer position of the intermediate transfer section 30 and the fixing section 50. In addition, the sheet conveyance path Tr includes a predetermined number of conveyance roll pairs 46a, 46b, 46c, and 46d, sheet guide members (not shown), and the like.

In the sheet feeding section 40, the sending device 42 sends the sheets 9 in the accommodation body 41 one by one to the sheet conveyance path Tr. Subsequently, on the sheet conveyance path Tr, the conveyance roll pair 46b sends the sheet 9 to the secondary transfer position of the intermediate transfer section 30 in synchronization with a secondary transfer timing.

Thereafter, in the intermediate transfer section 30, the secondary transfer device 34 performs secondary transfer of the toner images from the intermediate transfer belt 31 to one surface of the sheet 9 at the secondary transfer position.

The fixing section 50 is a section that heats the toner images transferred onto the sheet 9 under pressurization and fixes the toner images on the sheet 9.

The fixing section 50 has a heating rotator 52 and a pressurizing rotator 53 that rotate in a state of being press-contacted inside the housing 51. A fixing processing section (nip section) that introduces, pressurizes, and heats the sheet 9 is formed between the heating rotator 52 and the pressurizing rotator 53.

In the fixing section 50, the sheet 9 sent from the secondary transfer position of the intermediate transfer section 30 is introduced into the fixing processing section and passes through the fixing processing section.

In this case, in the fixing section 50, an unfixed toner image on the sheet 9 is heated under pressurization in a case where the sheet passes through the fixing processing section. As a result, the toner image is fixed, as an image, on the sheet 9.

Finally, in the image forming apparatus 1, the sheet conveyance path Tr conveys the sheet 9 discharged from the fixing section 50 toward the sheet discharge and accommodation section 12. As a result, the sheet 9 on which the image is formed is accommodated in the sheet discharge and accommodation section 12.

As described above, in the image forming apparatus 1, an operation (print operation) of forming an image is performed. As a result, the image forming apparatus 1 forms an image consisting of a developer (toner) on one surface of the sheet 9.

### Configuration Related to Replenishment of Developer

As shown in FIG. 2, the image forming apparatus 1 includes replenishment devices 6A, 6B, 6C, and 6D.

The replenishment devices 6A, 6B, 6C, and 6D are devices that individually replenish the developers of the colors (A, B, C, and D) corresponding to the development devices 25A, 25B, 25C, and 25D.

The replenishment devices 6A, 6B, 6C, and 6D include replenishment activation sections 61A, 61B, 61C, and 61D, developer containers 15A, 15B, 15C, and 15D, developer conveyance paths 17A, 17B, 17C, and 17D, and the like.

The replenishment activation sections 61A, 61B, 61C, and 61D each include a container drive section (not shown), a reception section for the developer, a sending member for the developer, and the like.

The container drive section is a section that drives a drive section of the developer container 15 to discharge the developer. The reception section of the developer is a section that receives the developer discharged from the developer container 15. The sending member of the developer is a member that sends the developer in the reception section.

The developer containers 15A, 15B, 15C, and 15D are containers that exclusively store the developers of the colors (A, B, C, and D) for replenishment. In the first exemplary embodiment, the toner is accommodated as the developer.

The developer containers 15A, 15B, 15C, and 15D are detachably attached to attachment sections 16A, 16B, 16C, and 16D provided in predetermined portions of the housing 10. A container in which a container itself rotates to send a developer or a container having a member that rotates to send a developer inside the container is used as the developer containers 15A, 15B, 15C, and 15D.

The developer conveyance paths 17A, 17B, 17C, and 17D are conveyance paths that individually convey the developers from the replenishment activation sections 61A, 61B, 61C, and 61D to the development devices 25A, 25B, 25C, and 25D.

In the replenishment devices 6A, 6B, 6C, and 6D, in a case where a replenishment timing arrives, the replenishment activation sections 61A, 61B, 61C, and 61D, which are targets that need to be replenished, are activated.

In this case, in the activated replenishment devices 6A, 6B, 6C, and 6D, predetermined amounts of developers are sent to the developer conveyance paths 17A, 17B, 17C, and 17D. In addition, the replenishment activation sections 61A, 61B, 61C, and 61D receive the developers in advance from the developer containers 15A, 15B, 15C, and 15D.

As a result, the replenishment devices 6A, 6B, 6C, and 6D convey and replenish predetermined amounts of developers to the development devices 25A, 25B, 25C, and 25D.

In addition, the replenishment device 6A, which is one of the replenishment devices 6A, 6B, 6C, and 6D, is activated by measurement information of a toner density measurement section 65.

The toner density measurement section 65 measures a toner density of the developer accommodated in the development device 25A as a measurement target. The toner density measurement section 65 is a first density detection unit as an example of a density detection unit.

The toner density measurement section 65 includes, for example, a magnetic permeability type TC sensor or the like in a case where a two-component developer contains a non-magnetic toner and a magnetic carrier.

In the magnetic permeability type TC sensor, a magnetic permeability of the developer accommodated in the development device 25A is measured. In the toner density measurement section 65, the toner density is obtained from the magnetic permeability of the developer as will be described below.

On the other hand, the remaining replenishment devices 6B, 6C, and 6D of the replenishment devices 6A, 6B, 6C, and 6D are activated by measurement information of a toner image density measurement section 67.

The toner image density measurement section 67 measures a density of a reference toner image. The density of the reference toner image is also a density of a developed toner amount. The toner image density measurement section 67 is a second density detection unit as another example of the density detection unit.

The reference toner image is a toner image for density measurement obtained by developing a specific electrostatic latent image with a development device of a measurement target. The reference toner image is formed on the photosensitive drum 22 or is formed by being transferred from the photosensitive drum 22 to the intermediate transfer belt 31.

In a case where the toner image density measurement section 67 measures a density of a reference toner image consisting of a chromatic (color) toner other than a black toner, the toner image density measurement section 67 is, for example, a diffuse reflection type development density sensor.

The toner image density measurement section 67 measures the density of the reference toner image of each color obtained by development by each of the development devices 25B, 25C, and 25D of the measurement targets. In addition, the toner image density measurement section 67 measures the density of the reference toner image primarily transferred onto the intermediate transfer belt 31 from each photosensitive drum 22 at a position in front of the secondary transfer position.

Further, in the image forming apparatus 1, a replenishment operation of the developer is controlled by adopting two developability control methods of ATC and ADC. The ATC is an abbreviation for auto toner concentration control, and the ADC is an abbreviation for auto density control.

The ATC measures the toner density in the development device by the toner density measurement section 65. The ATC is a method for controlling the replenishment of the toner such that the toner density in the development device, which is a replenishment target, becomes constant from measurement information of the toner density.

In the first exemplary embodiment, in a case where the measurement result of the toner density measurement section 65 is a density value equal to or greater than a first threshold value, the replenishment device 6A is configured to be activated. The first threshold value is an allowable lower limit value of an amount of deviation from a first allowable density value as the toner density in the development device 25A which is an ATC target.

Thus, the replenishment device 6A according to the first exemplary embodiment activates in a case where the density of the developer accommodated in the development device 25A reaches a predetermined value.

In addition, in the first exemplary embodiment, a developability controller 185 to be described later estimates a carrier amount in a unit volume developer from information on the magnetic permeability measured by the magnetic permeability type TC sensor. In addition, a developer replenishment operation controller 186 calculates a weight ratio between the toner and the carrier from the carrier amount to obtain information as the toner density.

Further, in the first exemplary embodiment, the measurement information of the toner density measurement section 65 is collected in the developability controller 185. Then, in the first exemplary embodiment, the developability controller 185 determines whether or not the measurement result of the toner density measurement section 65 is equal to or greater than the first threshold value.

The ADC is a method for controlling the replenishment of the toner such that the density of the reference toner image is measured by the toner image density measurement section 67 and development characteristics become constant.

In the first exemplary embodiment, in a case where the measurement result of the toner image density measurement section 67 is a density value equal to or greater than a second threshold value, each of the replenishment devices 6B, 6C, and 6D is activated. The second threshold value is an allowable lower limit value of an amount of deviation from a second allowable density value as an image density of each reference toner image obtained by being developed by each of the development devices 25B, 25C, and 25D which is an ADC target.

Thus, the replenishment devices 6B, 6C, and 6D are activated in a case where the density of each reference toner image is a predetermined value. The density of each reference toner image substantially corresponds to the density of each developer accommodated in the development devices 25B, 25C, and 25D.

In addition, in the first exemplary embodiment, the measurement information of the toner image density measurement section 67 is collected in the developability controller 185. Then, in the first exemplary embodiment, the developability controller 185 determines whether or not the measurement result of the toner image density measurement section 67 is the density value equal to or greater than the second threshold value.

The toner density measurement section 65 measures a toner density at a density measurement timing corresponding to the ATC (first measurement timing).

Specifically, the toner density measurement section 65 constantly measures the toner density while the development device 25A of the measurement target is working. In this case, the density measurement timing of the toner density measurement section 65 corresponding to the ATC is a timing while the development device 25A is working.

In addition, the toner image density measurement section 67 measures a toner image density at a density measurement timing corresponding to the ADC (second measurement timing). The second measurement timing at this time may be a timing different from the first measurement timing.

Specifically, the toner image density measurement section 67 measures the toner image density in a case where an amount (printing amount: PV) of an image forming operation reaches a predetermined threshold value. In this case, the density measurement timing of the toner image density measurement section 67 corresponding to the ADC is a timing at which the amount of the image forming operation reaches the predetermined threshold value.

The amount of the image forming operation is determined by using, for example, information such as the number of sheets 9 on which the images are formed and the number of pixels of the formed image. In addition, the amount of the image forming operation is a cumulative amount from a point in time at which an immediately preceding control operation among various control operations related to a process condition at the time of image forming executed in the image forming apparatus 1 is ended.

In addition, in the image forming apparatus 1, in a case where the image forming operation is performed, in a case where the replenishment devices 6A, 6B, 6C, and 6D reach an activation timing, the image forming operation being executed is interrupted.

Further, in the image forming apparatus 1, in a case where the image forming operation is performed, in a case where the toner image density measurement section 67 reaches a density measurement timing corresponding to the ADC, the image forming operation being executed is interrupted earlier. This is because an operation of forming the reference toner image which is a measurement target of the toner image density measurement section 67 is started earlier.

Thus, in the image forming apparatus 1, the activation timing of the replenishment device 6A activated based on the developability control method of the ATC and the activation timings of the replenishment devices 6B, 6C, and 6D activated based on the developability control method of the ADC are often executed individually at different timings from each other.

In other words, it can be said that a timing at which the image forming operation being executed in the replenishment operation of the replenishment device 6A is interrupted and timings at which the image forming operation being executed in the replenishment operations of the replenishment devices 6B, 6C, and 6D are interrupted are often timings different from each other.

Therefore, the image forming apparatus 1 includes a control unit 18 having a function of performing control to adjust the activation timing of the replenishment device 6A and the activation timings of the replenishment devices 6B, 6C, and 6D.

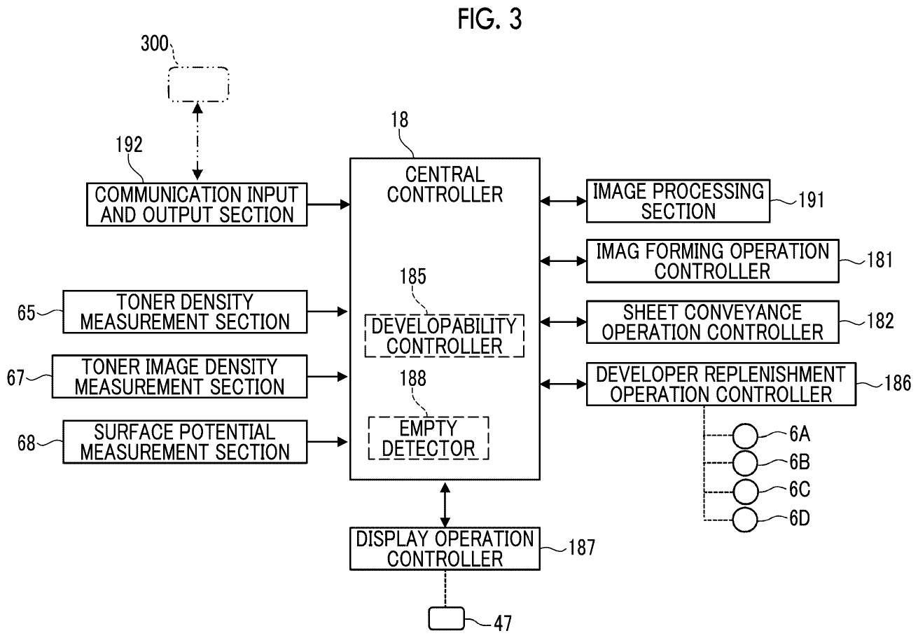

As shown in FIG. 3, the control unit 18 is a central controller including the developability controller 185 and the like.

The central controller of the control unit 18 is a unit that integrally controls the entire operation of the image forming apparatus 1. The control unit 18 is an arithmetic processing device (not shown), a storage, an input and output section, and the like. Other controllers to be described later also have substantially similar configurations.

The control unit 18 causes the arithmetic processing device to perform necessary processing based on a control program and control data stored in the storage while acquiring information necessary for the control. Then, the control unit 18 causes the arithmetic processing device or the like to transmit a signal for controlling an operation of a control target that needs to be controlled.

The information necessary for the control is, for example, detection information, input information, and the like.

As shown in FIG. 3, the control unit 18 is connected to the toner density measurement section 65, the toner image density measurement section 67, a surface potential measurement section 68, a communication input and output section 192, and the like.

As a result, the control unit 18 can acquire necessary detection information, input information, and the like.

Among these components, the surface potential measurement section 68 is a section that measures a surface potential of each photosensitive drum 22 in the imaging units 21A, 21B, 21C, and 21D. The surface potential measurement section 68 is a known potential sensor or the like. The communication input and output section 192 is a section that performs communication with or input and output of information to and from an external connection device 300, such as an information terminal or a storage medium.

In addition, an image processing section 191, an image forming operation controller 181, a sheet conveyance operation controller 182, a developer replenishment operation controller 186, a display operation controller 187, and the like are connected to the control unit 18. As a result, the control unit 18 can output a control signal to a necessary control target.

The image processing section 191 is a section that generates image signals to be formed by performing predetermined processing on image information and the like input to the image forming apparatus 1. In the image processing section 191, information such as the number of sheets 9 and the number of pixels forming the image is obtained.

The image forming operation controller 181 is a section that controls operations related to the imaging section 20, the intermediate transfer section 30, and the fixing section 50. The sheet conveyance operation controller 182 is a section that controls an operation related to the sheet feeding section 40 including the sheet conveyance path Tr.

The developer replenishment operation controller 186 is a section that controls an operation of (each of replenishment activation sections 61 of) the replenishment devices 6A, 6B, 6C, and 6D. The display operation controller 187 is a section that controls an operation related to the manipulation display panel section 47.

In addition, the central controller of the control unit 18 includes the developability controller 185 and an empty detector 188 as a part of functions thereof.

The developability controller 185 is a section that controls an operation related to each control method of the ATC and the ADC.

The developability controller 185 also performs the following control operation as an operation related to the control method of the ATC. That is, the developability controller 185 also performs an operation of collecting the measurement information of the toner density measurement section 65 and determining whether or not the measurement result is equal to or greater than the first threshold value.

In addition, the developability controller 185 also performs the following control operation as an operation related to the control method of the ADC. That is, the developability controller 185 also performs an operation of collecting the measurement information of the toner image density measurement section 67 and determining whether or not the measurement result is the density value equal to or greater than the second threshold value.

The empty detector 188 is a section that monitors residual amounts of the toners as replenishment targets accommodated in the developer containers 15A, 15B, 15C, and 15D. In addition, the empty detector 188 is a section that detects that the toner residual amount is substantially zero and the container is in an empty state as a result of the monitoring.

The empty detector 188 performs the empty detection by obtaining necessary information from the developability controller 185 and the like.

### Control Operation Related to Adjustment of Activation Timing of Replenishment Device

Next, a control operation of adjusting the activation timing of the replenishment device 6A during the image forming operation and the activation timings of the replenishment devices 6B, 6C, and 6D will be described.

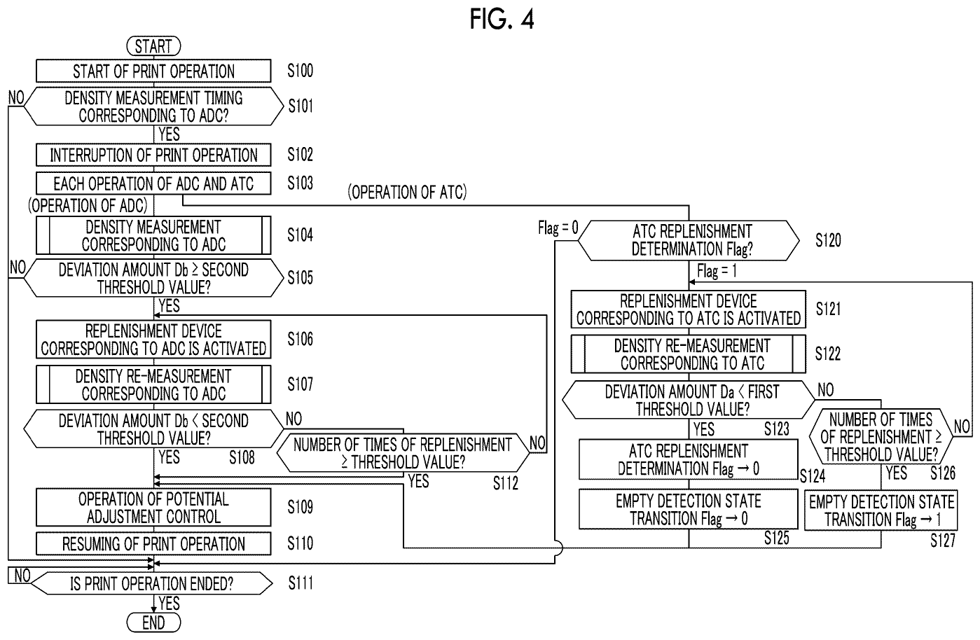

As shown in FIG. 4, in the image forming apparatus 1, in a case where the image forming operation (print operation) is started (S100), the control unit 18 determines whether or not the density measurement timing corresponding to the ADC arrives (S101).

S100 and S101 are abbreviated notations of step S100 and step S101. The abbreviated notation is similar in the case of other subsequent steps.

The density measurement timing corresponding to the ADC is a timing at which the amount of the image forming operation (printing amount: PV) reaches the predetermined threshold value. A cumulative value of the number of image forming sheets or the number of pixels is applied as the printing amount PV. The cumulative value in this case is a value accumulated from a point in time at which an immediately preceding control operation related to the process condition at the time of image forming is ended.

In a case where it is determined in step S101 that the density measurement timing corresponding to the ADC arrives, the print operation being executed is interrupted (S102). Thereafter, the operation related to the ADC and the operation related to the ATC are individually performed (S103).

### Operation Related to ADC

As shown in FIG. 4, density measurement corresponding to the ADC is first performed as the operation related to the ADC (S104).

In the density measurement corresponding to the ADC, the reference toner image of the measurement target is formed, and the density of the reference toner image is measured.

Specifically, after the imaging units 21A, 21B, 21C, and 21D are activated to form the reference toner images of the colors on the photosensitive drums 22 by the development devices 25B, 25C, and 25D, the reference toner images of the colors are primarily transferred onto the intermediate transfer belt 31. Subsequently, in a case where the reference toner images of the colors on the intermediate transfer belt 31 pass through the toner image density measurement section 67, the densities thereof are measured.

At this time, the information measured by the toner image density measurement section 67 is collected by the developability controller 185. In this case, in the developability controller 185, a deviation amount Db deviating from the second allowable density value as the image density of the reference toner image of each color is calculated from the measurement information.

Incidentally, the reference toner image of each color at this time is allowed to pass through without being secondarily transferred onto the sheet 9 at the secondary transfer position, and is then removed by the belt cleaning device 36.

Subsequently, the developability controller 185 determines whether or not the deviation amount Db of the density obtained from the measurement result of the toner image density measurement section 67 is equal to or greater than the second threshold value (S105).

As described above, the second threshold value is the allowable lower limit value of the amount of deviation from the second allowable density value.

In a case where it is determined in step S105 that the deviation amount Db is equal to or greater than the second threshold value, the corresponding replenishment device of the replenishment devices 6B, 6C, and 6D corresponding to the ADC is activated (S106).

The replenishment devices 6B, 6C, and 6D are activated in a case where any deviation amount Db is equal to or greater than the second threshold value. As a result, the replenishment devices 6B, 6C, and 6D replenish the developers of the predetermined colors (B, C, and D) to the development devices 25B, 25C, and 25D by predetermined amounts.

In a case where the corresponding replenishment device in step S105 is activated to perform the replenishment operation, the density measurement corresponding to the ADC is performed again (S107).

In this density re-measurement corresponding to the ADC, the formation of the reference toner image of the measurement target and the measurement of the density of the reference toner image are similarly performed again as in the first density measurement corresponding to the ADC.

In this case, the developability controller 185 determines whether or not the deviation amount Db of the density obtained from the measurement result of the toner image density measurement section 67 is less than the second threshold value (S108).

In a case where it is determined in step S108 that the deviation amount Db is less than the second threshold value, an operation of next potential adjustment control is performed (S109).

In a case where the deviation amount Db is less than the second threshold value, it is assumed that the density of the developer in any corresponding development device of the development devices 25B, 25C, and 25D by the replenishment operation returns to the second allowable density value and is recovered.

In the operation of the potential adjustment control, the surface potential of the photosensitive drum 22 measured by the surface potential measurement section 68 is checked.

In addition, the operation of the potential adjustment control is an operation of performing necessary adjustment related to potential setting in response to a variation in charge amount of the toner due to the replenishment of the developer and the like. Specifically, the operation of the potential adjustment control is an operation of performing necessary adjustment of development bias, necessary adjustment of a charging potential, a latent image potential, and the like, or the like.

After the operation of the potential adjustment control is performed, the print operation interrupted by the density measurement corresponding to the ADC or the replenishment operation performed as necessary is resumed (S110).

Finally, it is determined whether or not the resumed print operation is ended (S111). In this case, in a case where it is determined that the print operation is ended, all the print operations are ended.

In a case where a flow of the above operations is performed, the print operation being executed is interrupted by the operation of the density measurement corresponding to the ADC or the activation of the replenishment device corresponding to the ADC.

On the other hand, in a case where it is determined in step S101 that the density measurement timing corresponding to the ADC does not arrive, the print operation being executed is continued without being interrupted. In addition, even in a case where it is determined in step S105 that the deviation amount Db of the density is less than the second threshold value, the print operation being executed is continued without being interrupted.

In a case where such a flow of the operations is performed, it is determined whether or not the print operation being executed is ended (S111). In a case where it is determined that the print operation is ended, all the print operations are ended.

In a case where the latter flow of the operations is executed, the print operation being executed is continuously performed without being interrupted by the operation of the density measurement corresponding to the ADC or the activation of the replenishment device corresponding to the ADC.

Incidentally, in a case where it is determined in step S108 that the deviation amount Db is not less than the second threshold value and is equal to or greater than the second threshold value, the density of the developer in the corresponding development device in the replenishment operation does not return to the second allowable density value.

In this case, the developability controller 185 determines whether or not the number of times of the replenishment by the corresponding replenishment device among the replenishment devices 6B, 6C, and 6D is equal to or greater than a threshold value (S112).

The threshold value at this time is an upper limit value of the repetition number of times of repetition in which the toner in the developer container 15 is not empty and the replenishment operation can be performed.

In a case where it is determined in step S112 that the number of times of the replenishment is less than the threshold value, the operation returns to the activation of the corresponding replenishment device among the replenishment devices 6B, 6C, and 6D corresponding to the ADC in step S106.

In this case, the operations in steps S107 and S108 are similarly repeated with the replenishment operation in step S106 as the start.

On the contrary, in a case where it is determined in step S112 that the number of times of the replenishment is equal to or greater than the threshold value, the operation proceeds to the operation of the potential adjustment control in step S109.

In this case, no more replenishment operations cannot be performed and are prohibited.

In addition, in this case, it is determined that any developer container of the developer container 15B, 15C, or 15D that accommodates the toners of the corresponding colors in the empty detector 188 is in a state close to the empty state.

Operation Related to ATC

As shown in FIG. 4, in the operation related to the ATC, first, Flag of ATC replenishment determination is checked (S120).

In a case where the density measurement corresponding to the ATC to be described later is performed, the developability controller 185 sets the Flag of the ATC replenishment determination.

### Setting of ATC Replenishment Determination Flag

Here, the setting of the ATC replenishment determination Flag will be described in advance.

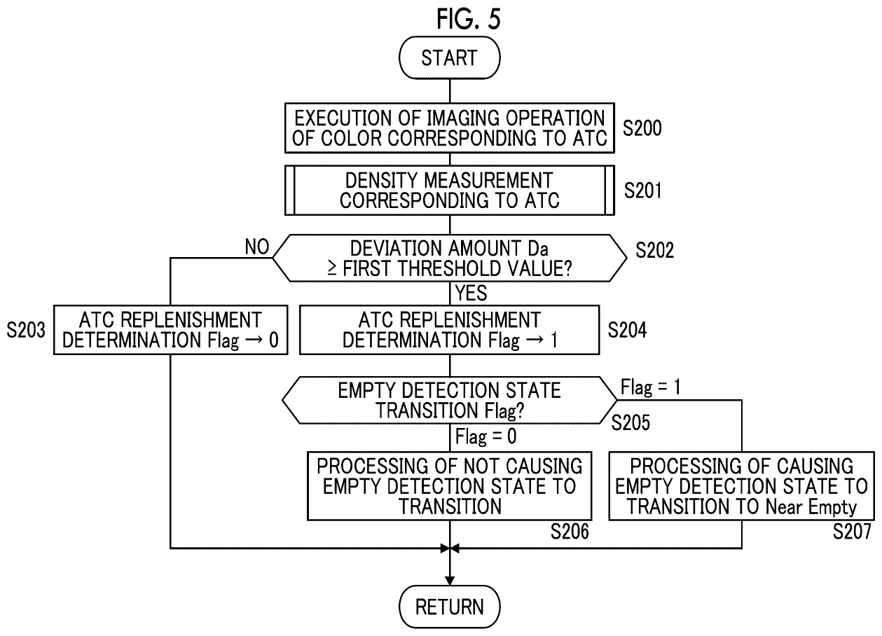

In this case, an imaging operation of a color corresponding to the ATC is executed as shown in FIG. 5 with the start of the print operation shown in FIG. 4 (S200).

In the first exemplary embodiment, the color corresponding to the ATC is “A color”, which is the color of the developer of the development device 25A in which the developability control of the ATC is performed.

In a case where the imaging operation for forming the toner image of the color corresponding to the ATC is executed, the density measurement corresponding to the ATC is performed (S201).

In the density measurement corresponding to the ATC, the toner density measurement section 65 measures the density of the developer accommodated in the development device 25A of the measurement target.

At this time, the information measured by the toner density measurement section 65 is collected by the developability controller 185. In this case, in the developability controller 185, the deviation amount Da deviating from the first allowable density value as the image density of the developer in the development device 25A is calculated from the measurement information.

Subsequently, the developability controller 185 determines whether or not the deviation amount Da of the density obtained from the measurement result of the toner density measurement section 65 is equal to or greater than the first threshold value (S202).

The first threshold value is the allowable lower limit value of the amount of deviation from the first allowable density value as described above.

In a case where it is determined in step S202 that the deviation amount Da is less than the first threshold value, since the developer does not need to be replenished to the development device 25A, the ATC replenishment determination Flag is set to “Flag=0” indicating that the developer does not need to be replenished (S203).

In this case, since the developer does not need to be replenished, the replenishment device 6A is not activated.

On the other hand, in a case where it is determined in step S202 that the deviation amount Da is equal to or greater than the first threshold value, since the developer needs to be replenished to the development device 25A, the ATC replenishment determination Flag is set to “Flag=1” indicating that the developer needs to be replenished (S204).

However, in this case, the ATC replenishment determination flag is merely set to “Flag=1”, and the replenishment device 6A corresponding to the ATC is not activated.

That is, in this case, the activation of the replenishment device 6A is set to be on standby.

Subsequently, after the ATC replenishment determination Flag is set to “Flag=1”, the developability controller 185 checks an empty detection state transition Flag set in the empty detector 188 (S205).

The setting of the empty detection state transition Flag will be described later.

In a case where the empty detection state transition Flag is “Flag=0” indicating that the empty detection state is prompted to transition in step S205, storage processing of not causing the empty detection state to transition is performed (S206).

In this case, the amount of the developer in the development device 25A corresponding to the ATC is reduced, and the developer container 15A that accommodates the developer to be replenished to the development device 25A is in a state close to the empty state. However, even in this state, the determination of the empty detection for the developer container 15A is on standby in the empty detector 188 by the storage processing.

As a result, in this case, a state where a work of replacing the developer container 15A with a new container is maintained without being performed. As a result, the print operation is not interrupted by the replacement work of the developer container 15A.

On the other hand, in a case where the empty detection state transition Flag is “Flag=1” indicating a timing at which the empty detection state is caused to transition in step S205, storage processing of causing the empty detection state to transition to “Near Empty” is performed for the empty detection state (S207).

The “Near Empty” is a determination item indicating that the developer container 15A is in a state close to the empty state.

In this case, the determination of the empty detection for the developer container 15A is also on standby in the empty detector 188 by the storage processing.

However, in this case, a warning message or the like for reporting that the developer container 15A is in the “Near Empty” state is displayed on the manipulation display panel section 47.

As a result, a user can be notified and alerted to the fact that a replacement timing of the developer container 15A is close.

### Continuation of Operation Related to ATC

Here, the operation related to the ATC shown in FIG. 4 will be described again.

In a case where it is determined in step S120 that the ATC replenishment determination Flag is “Flag =0”, the processing proceeds to step S111.

In this case, since the replenishment operation by the replenishment device 6A corresponding to the ATC is not necessary, the replenishment device 6A is not activated.

In addition, in this case, there are the following two cases for the interruption of the print operation.

One case is a case where the print operation being executed is interrupted by performing the operation of the density measurement corresponding to the ADC and the replenishment operation of at least one of replenishment device 6B, 6C, or 6D as necessary. Another example is a case where the operation of the density measurement corresponding to the ADC or the replenishment operation is not performed and the print operation being executed is not interrupted.

On the other hand, in a case where it is determined in step S120 that the ATC replenishment determination Flag is “Flag=1”, the replenishment device 6A corresponding to the ATC is activated (S121).

In this case, the replenishment device 6A is activated to replenish the developer of the A color to the development device 25A by a predetermined amount.

The replenishment device 6A corresponding to the ATC at this time is in a standby state of activation in step S204 shown in FIG. 5. However, the replenishment device 6A at this time is controlled to be started in a case where the density measurement corresponding to the ADC is performed.

In addition, it can be said that the replenishment device 6A at this time is controlled to be started by releasing the standby state when the density measurement timing corresponding to the ADC shown in step S101 arrives.

In a case where the replenishment device 6A corresponding to the ATC is activated to perform the replenishment operation, the density measurement corresponding to the ATC is performed again (S122).

In this density re-measurement corresponding the ATC, the density measurement of the developer in the development device 25A corresponding to ATC is performed again in a case of the first density measurement corresponding to the ATC shown in FIG. 5.

In a case where the density re-measurement corresponding to the ATC is performed, the developability controller 185 determines whether or not the deviation amount Da of the density obtained from the measurement result of the toner density measurement section 65 is less than the first threshold value (S123).

In a case where it is determined in step S123 that the deviation amount Da is less than the first threshold value, the density of the developer in the development device 25A is recovered to the first allowable density value by the replenishment operation of the replenishment device 6A.

In this case, the developability controller 185 changes the ATC replenishment determination Flag to “Flag =0” (S124). That is, in this case, the processing is performed on the assumption that the replenishment operation of the replenishment device 6A corresponding to the ATC is not necessary.

In addition, in this case, since the replenishment operation of the replenishment device 6A is performed, the developability controller 185 sets the empty detection state transition Flag to “Flag =0” (S125).

That is, in this case, the processing is performed under the assumption that the developer container 15A that accommodates the developer to be replenished to the replenishment device 6A may not be in the empty state.

Subsequently, after the processing of steps S124 and S125 is performed, the processing proceeds to step S109, the operation of the potential adjustment control is performed.

In this case, since the developer is replenished to the development device 25A by the activation of the replenishment device 6A, the operation of the potential adjustment control described above is similarly performed.

In addition, the operation of the potential adjustment control at this time is performed at once in a case where both the replenishment operation corresponding to the ADC and the replenishment operation corresponding to the ATC are performed.

The operation of the potential adjustment control performed at once may shorten a time of interruption of the print operation as compared with a case where the replenishment operation corresponding to the ADC and the replenishment operation corresponding to the ATC are individually performed at different timings and the operation of the potential adjustment control is individually performed after each replenishment operation is ended.

After the operation of the potential adjustment control at this time is performed, the print operation interrupted by the density measurement corresponding to the ADC or the replenishment operation performed as necessary is resumed (S110).

Finally, it is determined whether or not the resumed print operation is ended (S111). In a case where it is determined that the print operation is ended, all the print operations are ended.

In a case where the flow of the above operations is performed, the print operation being executed is interrupted by performing the operation of the density measurement corresponding to the ADC or the replenishment operation of the replenishment device corresponding to the ADC.

However, in this case, the replenishment operation of the replenishment device 6A corresponding to the ATC is performed during the interruption.

Incidentally, in a case where it is determined in step S123 that the deviation amount Da is equal to or greater than the first threshold value, it is determined whether or not the number of times of the replenishment performed by the replenishment device 6A is equal to or greater than the threshold value (S126).

In this case, in a case where it is determined that the number of times of the replenishment is less than the threshold value, the density of the developer in the development device 25A is not recovered to the first allowable density value. Thus, in this case, the processing proceeds to step S121, and the replenishment operation of the replenishment device 6A and each operation of subsequent steps S122 and S123 are similarly repeated.

In a case where it is determined in step S126 that the number of times of the replenishment is equal to or greater than the threshold value, the replenishment operation of the replenishment device 6A is performed. Thus, in this case, the developability controller 185 sets the empty detection state transition Flag to “Flag =1” (S127).

That is, in this case, the processing is performed under the assumption that the developer container 15A that accommodates the developer to be replenished to the replenishment device 6A may be in the empty state.

After the operation of step S127 is ended, the processing proceeds to step S109, and the operation of the potential adjustment control is performed similarly to a case where the operation of step S125 is ended.

As described above, in the image forming apparatus 1, the activation timing of the replenishment device 6A and the activation timings of the replenishment devices 6B, 6C, and 6D during the image forming operation are adjusted.

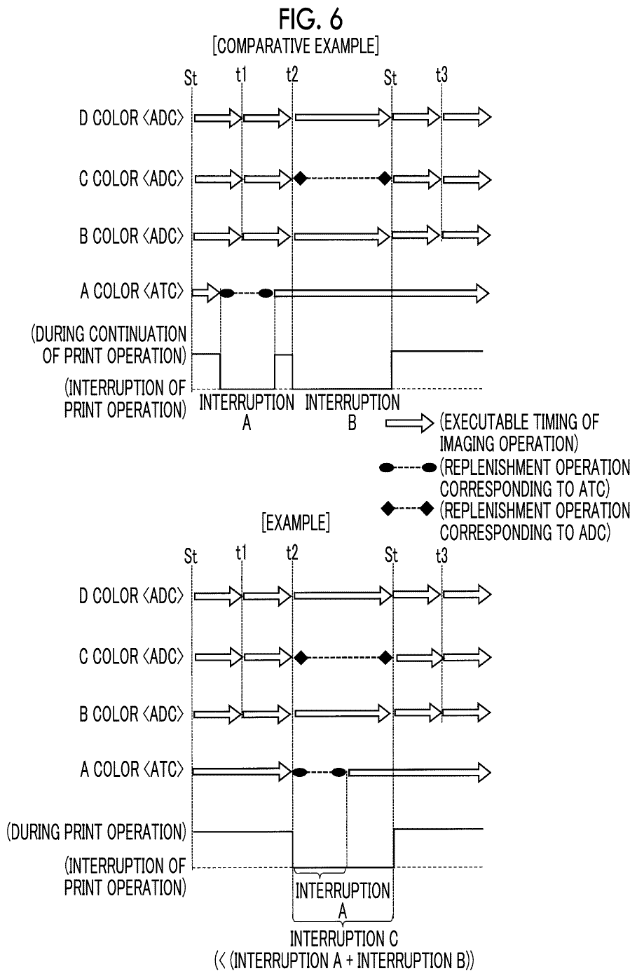

Specifically, as conceptually shown in a lower part of FIG. 6, in the image forming apparatus 1, the replenishment device 6A corresponding to the ATC is controlled to be activated at the same timing as the activation timing of any of the replenishment device 6B, 6C, or 6D corresponding to the ADC.

This can also be conceived as controlling the activation of the replenishment device 6A corresponding to the ATC to be on standby for the activation timing of any of the replenishment device 6B, 6C, or 6D corresponding to the ADC in the image forming apparatus 1.

The same timing described above refers that the activation timing of the replenishment device 6A and the activation timing of any of the replenishment device 6B, 6C, or 6D may be at least partially the same timing. Thus, the same timing described above is used as a phrase including not only a case where the activation timing of the replenishment device 6A and the activation timing of any of the replenishment device 6B, 6C, or 6D coincide with each other, but also a case where the activation timings overlap at least partially.

FIG. 6 shows states of the following two imaging operations and the replenishment operation.

That is, one imaging operation is a state of the imaging operation and the replenishment operation in the imaging unit 21A of the A color in which the developability control of the ATC is performed. Another imaging operation is a state of the imaging operation and the replenishment operation in the imaging units 21B, 21C, and 21D of the B color, C color, and D color in which the developability control of the ADC is performed.

Reference numeral St in FIG. 6 denotes a start point in time of cumulative count of the printing amount PV corresponding to the density measurement timing of the ADC. In addition, reference numerals t1 to t3 in FIG. 6 denote arrival point in times of the density measurement timing of the ADC, that is, points in time arrived from the start point in time St.

In addition, in FIG. 6, a case where the replenishment device 6B of the replenishment devices 6B, 6C, and 6D corresponding to the ADC is activated is shown.

Interruption A shown in FIG. 6 is an interruption time in a case where the replenishment operation of the developer of the A color corresponding to the ATC is interrupted. Interruption B shown in FIG. 6 is an interruption time in a case where the replenishment operation of the developer of the B color corresponding to the ADC is interrupted.

The reason why Interruption B is longer than Interruption A is that, in the developability control of the ADC, a time required for the forming operation of the reference toner image and the operation of the density measurement of the reference toner image is included in addition to the replenishment operation.

A comparative example shown in an upper part of FIG. 6 is an example in a case where the replenishment device 6A corresponding to the ATC and one replenishment device 6B corresponding to the ADC are activated individually without adjusting the activation timings of each other.

In the comparative example, the replenishment device 6A and the replenishment device 6B may be completely separated and activated at different timings.

In this case, the print operation is interrupted for a time obtained by adding Interruption A and Interruption B. In addition, in this case, the print operation may be interrupted twice, which are Interruption A and Interruption B, at different timings.

Accordingly, according to the image forming apparatus 1, the image forming operation is less likely to be interrupted by the replenishment operation of the developer as compared with a case where the replenishment devices 6A and the replenishment devices 6B, 6C, and 6D are individually activated without adjusting the activation timings of each other during the image forming operation. The case where the replenishment devices are individually activated is, for example, a case of the comparative example shown in the upper part of FIG. 6.

More specifically, according to the image forming apparatus 1, as in the example shown in the lower part of FIG. 6, the replenishment device 6A is activated at the same timing partially overlapping the activation timing of the replenishment device 6B.

As a result, Interruption C of the print operation at this time is shorter than a time obtained by adding Interruption A and Interruption B at different timings in the comparative example, as shown in the example shown in the lower part of FIG. 6.

In addition, as shown in the comparative example, in the image forming apparatus 1, the replenishment timing of the replenishment device 6A corresponding to the ATC has already arrived before the density measurement timing corresponding to the ADC reaches t1.

However, in the image forming apparatus 1, even in this case, when the density measurement timing corresponding to the ADC arrives t2 and the density corresponding to the ADC is measured, the replenishment device 6A corresponding to the ATC is started.

As a result, in the image forming apparatus 1, the print operation is not interrupted by starting the replenishment device 6A corresponding to the ATC before the density corresponding to the ADC is measured.

That is, in the image forming apparatus 1, the print operation is less likely to be interrupted by the replenishment operation of the developer to an extent that the interruption of the print operation is avoided at such a timing.

Further, in the image forming apparatus 1, in a case where the density measurement timing corresponding to the ADC arrives, the replenishment device 6A corresponding to the ATC can be immediately started. This is because the replenishment device 6A does not have the forming operation of the reference toner image required for the density measurement corresponding to the ADC and the density measurement operation of the reference toner image.

Thus, in the image forming apparatus 1, in a case where the replenishment operation using the replenishment device 6B and the like corresponding to the ADC is required, the replenishment device 6B and the like corresponding to the ADC is started while the replenishment device 6A corresponding to the ATC is activated for the replenishment operation.

As a result, according to the image forming apparatus 1, the activation timing of the replenishment device 6A corresponding to the ATC and the activation timing of the replenishment device 6B and the like corresponding to the ADC overlap with each other at least partially as shown in the example in the lower part of FIG. 6. As a result, in the image forming apparatus 1, a time during which the print operation is interrupted by the overlapping portion is shortened.

In the developability controller 185 in the image forming apparatus 1, in a case where the developability control of the ATC is performed, a value consisting of the deviation amount smaller than the deviation amount of the second threshold value from the second allowable density value is used as the first threshold value.

The small deviation amount as the first threshold value at this time is, for example, the following value.

That is, the small deviation amount is a value adjusted to satisfy a condition in which the density of the reference toner image obtained by performing the development by the development device 25A corresponding to the ATC after the replenishment operation of the standby replenishment device 6A corresponding to the ATC is performed is an allowable density.

As a result, in the image forming apparatus 1, even in a case where the replenishment of the developer from the replenishment device 6A corresponding to the ATC to the development device 25A corresponding to the ATC is delayed due to the standby, deterioration in development characteristics of the development device 25A may be suppressed.

That is, in this case, the deterioration in development characteristics of the development device 25A is suppressed as compared with a case where the threshold value consisting of the deviation amount smaller than the deviation amount of the second threshold value from the second allowable density value is not applied as the first threshold value.

### Modification Example

The present invention is not limited to the configuration illustrated as the first exemplary embodiment. That is, the present invention can be modified or improved in various manners within a range not departing from the gist of inventions described in the claims.

Thus, the present invention also includes, for example, the following modification examples.

In the first exemplary embodiment, the image forming apparatus 1 including four development devices 25 has been described. However, the image forming apparatus 1 may include a plurality of development devices that accommodate different types (colors and the like) of developers as the development devices 25. Thus, the number of the plurality of development devices is not limited to four.

In addition, in the first exemplary embodiment, a case where the replenishment device corresponding to the ATC (an example of a first replenishment unit) is one replenishment device 6A has been described. However, the replenishment device corresponding to the ATC may be a plurality of replenishment devices.

Further, in the first exemplary embodiment, a case where the replenishment device corresponding to the ADC (an example of a second replenishment unit) is the remaining replenishment devices 6B to 6D other than the replenishment device 6A has been described. However, the replenishment device corresponding to the ADC may be the other plurality of replenishment devices or may be one replenishment device.

The image forming apparatus according to the exemplary embodiment of the present invention may be an image forming apparatus that adopts a direct transfer method instead of the intermediate transfer section 30 as long as the image forming apparatus includes the plurality of development devices. The direct transfer method in this case is a transfer method of directly transferring the toner image from the photosensitive drum 22 onto the sheet 9.

The image forming apparatus adopting the direct transfer method is configured to, for example, convey the sheet 9 by a conveyor belt or the like such that the transfer positions of the photosensitive drums 22 of the plurality of imaging units 21 sequentially pass through the transfer position.

### Supplementary Note

(((1)))

An image forming apparatus comprising:
a plurality of development devices that accommodate different types of developers from each other;
a first replenishment unit that replenishes a developer to at least one development device of the plurality of development devices in a case where a density of the developer in the at least one development device is a predetermined value;
a second replenishment unit that replenishes the developer to a remaining development device of the plurality of development devices in a case where a density of the developer in the remaining development device is a predetermined value; and
a control unit that controls the first replenishment unit to be activated at a same timing as an activation timing of the second replenishment unit.
(((2)))

An image forming apparatus comprising:
a plurality of development devices that accommodate different types of developers from each other;
a first replenishment unit that replenishes a developer to at least one development device of the plurality of development devices in a case where a result obtained by measuring a density of the developer in the at least one development device at a first measurement timing is a predetermined value;
a second replenishment unit that replenishes the developer to a remaining development device of the plurality of development devices in a case where a result obtained by measuring a density of the developer in the remaining development device at a second measurement timing different from the first measurement timing is a predetermined value; and
a control unit that controls an activation of the first replenishment unit to be on a standby until the second measurement timing.
(((3)))

The image forming apparatus according to (((1))),
wherein the control unit starts the first replenishment unit in a case where the density of the developer in the remaining development device is measured.
(((4)))

The image forming apparatus according to (((2))),
wherein the control unit starts the standby first replenishment unit in a case where the second measurement timing arrives.
(((5)))

The image forming apparatus according to (((3))),
wherein the control unit starts the second replenishment unit during the activation of the first replenishment unit.
(((6)))

The image forming apparatus according to (((4))),
wherein the control unit starts the second replenishment unit during the activation of the first replenishment unit.
(((7)))

The image forming apparatus according to any one of (((1))) to (((6))),
wherein the predetermined value in the first replenishment unit is a value equal to or greater than a first threshold value which is an allowable lower limit value deviating from a first allowable density value of the developer in the at least one development device,
the predetermined value in the second replenishment unit is a value equal to or greater than a second threshold value which is an allowable lower limit value deviating from a second allowable density value of the developer in the remaining development device, and
the control unit uses, as the first threshold value, a value consisting of a deviation amount smaller than a deviation amount of the second threshold value from the second allowable density value.
(((8)))

The image forming apparatus according to any one of (((1))) to (((7))),
wherein, in a case where the density of the developer is returned to an allowable density value at a stage in which a number of times of the replenishment of the first replenishment unit does not exceed an upper limit value, the control unit retains, as a determination result indicating that the developer is not empty until the density of the developer in the remaining development device is measured, a result of empty detection of determining that the developer in the at least one development device is empty.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a plurality of development devices that accommodate different types of developers from each other;
a first replenishment unit that replenishes a developer to at least one development device of the plurality of development devices in a case where a density of the developer in the at least one development device is a predetermined value;
a second replenishment unit that replenishes the developer to a remaining development device of the plurality of development devices in a case where a density of the developer in the remaining development device is a predetermined value; and
a control unit that controls the first replenishment unit to be activated at a same timing as an activation timing of the second replenishment unit.

2. An image forming apparatus comprising:
a plurality of development devices that accommodate different types of developers from each other;
a first replenishment unit that replenishes a developer to at least one development device of the plurality of development devices in a case where a result obtained by measuring a density of the developer in the at least one development device at a first measurement timing is a predetermined value;
a second replenishment unit that replenishes the developer to a remaining development device of the plurality of development devices in a case where a result obtained by measuring a density of the developer in the remaining development device at a second measurement timing different from the first measurement timing is a predetermined value; and
a control unit that controls an activation of the first replenishment unit to be on a standby until the second measurement timing.

3. The image forming apparatus according to claim 1,
wherein the control unit starts the first replenishment unit in a case where the density of the developer in the remaining development device is measured.

4. The image forming apparatus according to claim 2,
wherein the control unit starts the standby first replenishment unit in a case where the second measurement timing arrives.

5. The image forming apparatus according to claim 3,
wherein the control unit starts the second replenishment unit during the activation of the first replenishment unit.

6. The image forming apparatus according to claim 4,
wherein the control unit starts the second replenishment unit during the activation of the first replenishment unit.

7. The image forming apparatus according to claim 1,
wherein the predetermined value in the first replenishment unit is a value equal to or greater than a first threshold value which is an allowable lower limit value deviating from a first allowable density value of the developer in the at least one development device,
the predetermined value in the second replenishment unit is a value equal to or greater than a second threshold value which is an allowable lower limit value deviating from a second allowable density value of the developer in the remaining development device, and
the control unit uses, as the first threshold value, a value consisting of a deviation amount smaller than a deviation amount of the second threshold value from the second allowable density value.

8. The image forming apparatus according to claim 2,
wherein the predetermined value in the first replenishment unit is a value equal to or greater than a first threshold value which is an allowable lower limit value deviating from a first allowable density value of the developer in the at least one development device,
the predetermined value in the second replenishment unit is a value equal to or greater than a second threshold value which is an allowable lower limit value deviating from a second allowable density value of the developer in the remaining development device, and
the control unit uses, as the first threshold value, a value consisting of a deviation amount smaller than a deviation amount of the second threshold value from the second allowable density value.

9. The image forming apparatus according to claim 1,
wherein, in a case where the density of the developer is returned to an allowable density value at a stage in which a number of times of the replenishment of the first replenishment unit does not exceed an upper limit value, the control unit retains, as a determination result indicating that the developer is not empty until the density of the developer in the remaining development device is measured, a result of empty detection of determining that the developer in the at least one development device is empty.

10. The image forming apparatus according to claim 2,
wherein, in a case where the density of the developer is returned to an allowable density value at a stage in which a number of times of the replenishment of the first replenishment unit does not exceed an upper limit value, the control unit retains, as a determination result indicating that the developer is not empty until the density of the developer in the remaining development device is measured, a result of empty detection of determining that the developer in the at least one development device is empty.
